(19) United States
(12) Patent Application Publication
(10) Pub. No.: US 2026/0316973 A1
(43) Pub. Date: Oct. 15, 2026

(54) PROPULSION SYSTEM

(71) Applicant: Malek BHAIRI, La Verne, CA (US)

(72) Inventor: Malek BHAIRI, La Verne, CA (US)

(21) Appl. No.: 19/281,730

(22) Filed: Jul. 27, 2025

Related U.S. Application Data
(60) Provisional application No. 63/676,356, filed on Jul. 27, 2024.

(51) Int. Cl. B64U 50/18

(52) U.S. Cl. CPC B64U 50/18

(57) ABSTRACT

The invention provides a propulsion system that uses ducts in combination with a valve and thrust source. The invention's use of ducts eliminates the need for propeller-based propulsion thereby permitting the propulsion source to be placed internally within a vehicle, such as an aerial drone, thereby providing the vehicle with a more aerodynamic design and reduced noise of operation.

### CROSS-REFERENCE TO RELATED APPLICATIONS

This application claims the benefit of provisional Application No. 63/676,356, filed Jul. 27, 2024, the entire contents of which are incorporated herein by reference for all purposes.

### FIELD OF THE INVENTION

The invention generally relates to propulsion. More particularly, the invention relates to propulsion systems for arial drones and other vehicles.

### BACKGROUND OF THE INVENTION

Aerial drones are known in the art and use propeller-based propulsion systems. While suitable for powering drones, propeller-based propulsion suffers a number of significant disadvantages. Propeller-based propulsion systems are noisy and their operation creates a nuisance. Propeller-based propulsion systems also rely on externally located props and motors which create drag and compromise the aerodynamic performance of conventional drones. Propeller-based propulsion systems also induce drag due to vortices created around the tips of the propeller blades during lift generation causing resistance against the propeller blades requiring increased engine power and reducing overall efficiency.

What is needed therefore is a drone propulsion system capable of avoiding the inefficiencies of known propulsion systems while simultaneously operating with reduced noise.

### SUMMARY OF THE INVENTION

The invention uses ducts in communication with a thrust module to provide a propulsion system that operates more efficiently and quietly than conventional propeller-based propulsion systems. A valve is interposed between the system's exhaust ducts and thrust modules to direct forced air from the thrust modules to one or a combination of exhaust ducts thereby providing a range of exhaust thrust angles. When forced air is directed to a combination of exhaust ducts, the exhaust ducts cooperate to provide a combined forced air exhaust the angle of which is determined by the relative amount of forced air that is directed to each exhaust duct.

Without being limited to any theory or mechanism, using a duct-based system to avoid the use of propellers reduces drag and noise and capitalizes on the entrainment of ambient air to provide a greater, more efficient thrust than conventional propeller-based systems. The inventive duct-based propulsion system also permits the internalization of the propulsion system components to provide a more streamlined vehicle profile which can increase aerodynamic lift, such as in a flying wing applications.

### BRIEF DESCRIPTION OF THE DRAWINGS

FIG. 1 shows an embodiment of the inventive propulsion system producing thrust at an angle of 90 degrees.

FIG. 2 shows the exhaust duct inlet of the inventive propulsion system from FIG. 1, wherein the valve is in a position to direct vector force to a single exhaust duct and produce thrust at an angle of 90 degrees.

FIG. 3 shows a cross-sectional view of the exhaust duct inlet of FIG. 2.

FIG. 4 shows an embodiment of the inventive propulsion system producing thrust at an angle of 180 degrees.

FIG. 5 shows the exhaust duct inlet of the inventive propulsion system from FIG. 4, wherein the valve is in a position to direct vector force to a single exhaust duct and produce thrust at an angle of 180 degrees.

FIG. 6 shows a cross-sectional view of the exhaust duct inlet of FIG. 5.

FIG. 7 shows an embodiment of the inventive propulsion system producing thrust at an angle of 160 degrees.

FIG. 8 shows the exhaust duct inlet of the inventive propulsion system from FIG. 7, wherein the valve is in a position to simultaneously direct vector force to first and second exhaust ducts to produce thrust at an angle of 160 degrees.

FIG. 9 shows a cross-sectional view of the exhaust duct inlet of FIG. 8.

FIG. 10 is a plan view of a drone showing ambient air flow into three of an embodiment of air inlets for use with the inventive propulsion system.

FIG. 11 shows a top, cross-sectional view of a drone incorporating three of an embodiment of intake modules for use with the inventive propulsion system.

FIG. 12 shows a bottom, cross-sectional view of a drone incorporating three of an embodiment of the inventive propulsion system.

FIG. 13 shows an embodiment of an intake module for use with the inventive propulsion system.

FIG. 14 shows the inefficiency of conventional propeller-based propulsion systems resulting from the creation of vortices.

FIG. 15 shows the cross-section of an aerial drone incorporating the inventive propulsion system and illustrating air flow and entrainment of ambient air produced by the inventive propulsion system.

FIG. 16 shows the direction of travel of an aerial drone incorporating three of the inventive propulsion system, wherein the drone is moving upwards or downwards.

FIG. 17 shows the direction of travel of an aerial drone incorporating three of the inventive propulsion system, wherein the drone is traveling in a pitch-leftward movement.

FIG. 18 shows the direction of travel of an aerial drone incorporating three of the inventive propulsion system, wherein the drone is traveling in a pitch-rightward movement.

FIG. 19 shows the direction of travel of an aerial drone incorporating three of the inventive propulsion system, wherein the drone is travelling in a pitch-forward movement.

FIG. 20 shows the direction of travel of an aerial drone incorporating three of the inventive propulsion system, wherein the drone is travelling in a pitch-rearward movement.

FIG. 21 shows the direction of travel of an aerial drone incorporating three of the inventive propulsion system, wherein the drone is rotating towards the right.

FIG. 22 shows the direction of travel of an aerial drone incorporating three of the inventive propulsion system, wherein the drone is rotating towards the left.

FIG. 23 shows a cross-sectional view of an aerial drone incorporating three of an embodiment of an exhaust duct housing for use with the inventive propulsion system.

FIG. 24 shows an embodiment of an exhaust duct housing for use with the inventive propulsion system, wherein the housing is producing thrust at an angle of 180 degrees.

FIG. 25 shows a cross-sectional view of a portion of the exhaust duct housing from FIG. 24, wherein the valve is in a position to produce thrust at an angle of 180 degrees.

FIG. 26 shows an embodiment of an exhaust duct housing for use with the inventive propulsion system, wherein the housing is producing thrust at an angle of 90 degrees.

FIG. 27 shows a cross-sectional view of a portion of the exhaust duct housing from FIG. 26, wherein the valve is in a position to produce thrust at an angle of 90 degrees.

FIG. 28 shows an embodiment of an exhaust duct housing for use with the inventive propulsion system, wherein the housing is producing thrust at an angle of between 90 and 180 degrees.

FIG. 29 shows a cross-sectional view of a portion of the exhaust duct housing from FIG. 28, wherein the valve is in a position to produce thrust at an angle of between 90 and 180 degrees.

The figures referred to above are not drawn necessarily to scale and should be understood to present a representation of the invention, illustrative of the principles involved. Some features of the propulsion system depicted in the drawings may have been enlarged or distorted relative to others to facilitate explanation and understanding. The same reference numbers are used in the drawings for similar or identical components and features shown in various alternative embodiments. The propulsion system, as disclosed herein, can have configurations and components determined, in part, by the intended application and environment in which it is used.

### DETAILED DESCRIPTION

The inventive propulsion system comprises a thrust module in communication with a series of ducts that cooperate to produce one or more angles of thrust. A valve positioned between exhaust ducts and the thrust module allocates vector force from the thrust module to the exhaust ducts thereby permitting the exhaust ducts to produce a single vector force, or cooperate to produce a combined vector force having a desired angle of thrust.

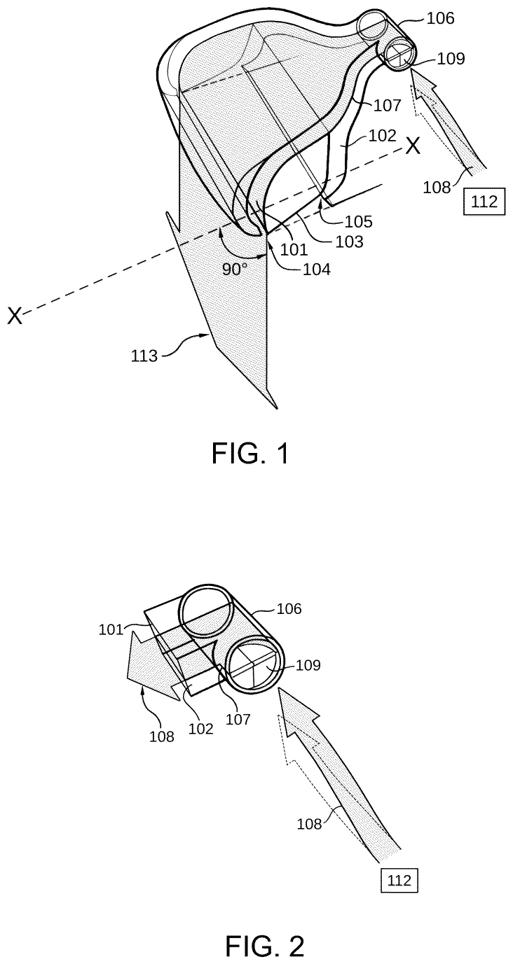

FIG. 1 shows a non-limiting arrangement of the ducts of the inventive propulsion system having first exhaust duct 101 and second exhaust duct 102. The ducts can be separated from one another by exhaust thrust plane 103 and separation body 107. First exhaust duct 101 terminates in first exhaust outlet 104 and second exhaust duct 102 terminates in second exhaust outlet 105. It will be appreciated that first exhaust outlet 104 and second exhaust outlet 105 can form openings on the outer surface of the body of a drone so as to permit exhaust thrust vectors to escape from, and propel, the drone. First exhaust outlet 104 and second exhaust outlet 105 can be oriented to provide thrust at an angle relative to horizontal plane X. For example, first exhaust outlet 104 can be adapted to produce exhaust thrust vector 113 at an angle of about 90 degrees and second exhaust outlet 105 can be adapted to produce exhaust thrust at an angle of about 180 degrees, each angle being relative to horizontal plane X. Horizontal plane X can be the longitudinal axis of the body of a drone. It will be appreciated that the 90 and 180 degree angles of thrust disclosed herein are non-limiting angles of thrust for the arrangement of exhaust outlets 104 and 105. For example, first exhaust outlet 104 can be arranged to produce thrust at an angle of between about 75 and 90 degrees relative to horizontal plane X, while second exhaust outlet 105 can be arranged to produce thrust at an angle of between about 160 and 180 degrees relative to horizontal plane X. As used herein, the term “about” means the value that is referenced, or that vary (plus or minus) by up to 5%, up to 10%, up to 15%, or up to 20% of the referenced value. First exhaust outlet 104 can have an opening cross section that is parallel horizontal plane X, while second exhaust outlet 105 can have an opening cross section that is perpendicular to horizontal plane X.

The opposing ends of first exhaust duct 101 and second exhaust duct 102 terminate in exhaust duct inlet 106 which is a hollow body and receives vector force 108 (e.g., forced air) from thrust module 112. Exhaust duct inlet 106 comprises separation body 107 to separate first exhaust duct 101 from second exhaust duct 102. That is, separation body 107 can extend along a length of first exhaust duct 101 and second exhaust duct 102, and into exhaust duct inlet 106, wherein separation body 107 connects to an inside wall of exhaust duct inlet 106 opposite first exhaust duct 101 and second exhaust duct 102. Exhaust duct inlet 106 is in fluid communication with valve 109 at one end, and terminates in a closed end opposite valve 109 such that vector force 108 from a thrust module can be forced into first exhaust duct 101, second exhaust duct 102, or combination thereof. Exhaust duct inlet 106 can be cylindrical in shape and bifurcated to form the ends of first exhaust duct 101 and second exhaust duct 102.

First exhaust duct 101 and second exhaust duct 102 can assume a tapering configuration, wherein the width of the ducts adjacent to exhaust duct inlet 106 is narrower than the width of the ducts at exhaust outlets 104 and 105. In other embodiments, exhaust duct 101 and second exhaust duct 102 assume a tapering configuration, wherein the width the ducts adjacent to exhaust duct inlet 106 is wider than the width of the ducts at exhaust outlets 104 and 105. Exhaust outlets 104 and 105 can have the shape of narrow, longitudinal vents, such as slits, for example. Without being limited to any particular theory or mechanism, arranging exhaust outlets 104 and 105 as narrow, longitudinal vents increases the surface area of their openings and provides greater absorption of sound waves produced by the operation of a thrust module that is in communication with the outlets. While exhaust outlets 104 and 105 are shown as longitudinal vents, it will be appreciated that the exhaust outlets can assume any shape or configuration suitable for channeling exhaust thrust as disclosed herein. Non-limiting cross-sectional shapes for exhaust outlets 104 and 105 include, but are not limited to, rectangular, oval, elliptical, crescent-shaped, or combinations thereof. In a preferred embodiment, exhaust outlets 104 and 105 are longitudinal vents having a width of 1 to 2 mm. It will be appreciated that arranging exhaust outlets 104 and 105 as longitudinal vents can produce a single exhaust thrust vector 113, and combined exhaust thrust vector 111, as planes (e.g., blades) of forced air.

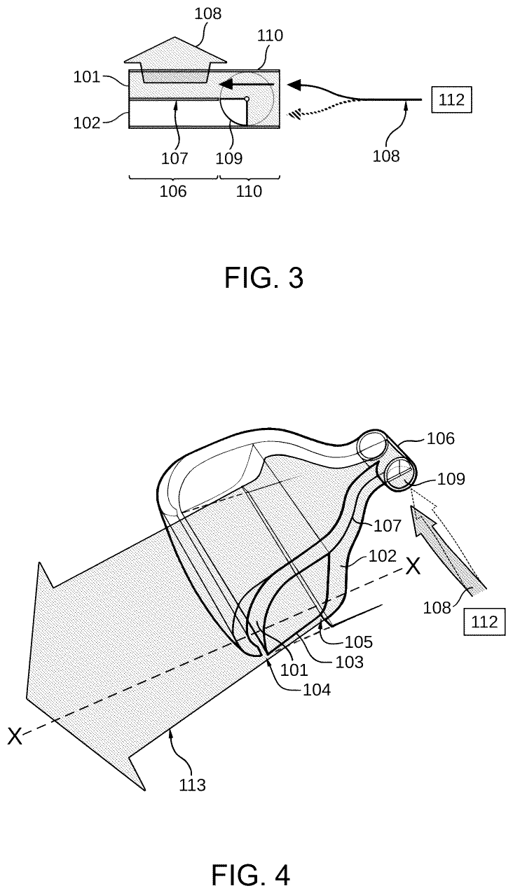

FIG. 3 shows a cross-sectional view of exhaust duct inlet 106 with valve 109 contained within valve housing 110. Valve housing 110 is in fluid communication with exhaust duct inlet 106 so as to direct vector force 108 from a thrust module to first exhaust duct 101 and second exhaust duct 102 thereby permitting an exhaust thrust vector to exit the propulsion system through first exhaust outlet 104 and second exhaust outlet 105. Valve 109 is rotatably connected to valve housing 110 so as to permit valve 109 to direct vector force 108 to first exhaust duct 101, second exhaust duct 102, or a combination thereof. Thus, valve 109 is adapted to apportion force to one or a combination of first exhaust duct 101 and second exhaust duct 102 to achieve a range of thrust vectors relative to horizontal plane X. Valve 109 can be adapted to rotate about a shaft that traverses the width of valve housing 110, wherein the shaft is connected to opposing, inside walls of valve housing 110. Alternatively, valve 109 can be adapted to rotate about a pair of opposing pins that protrude from the inside walls of valve housing 110.

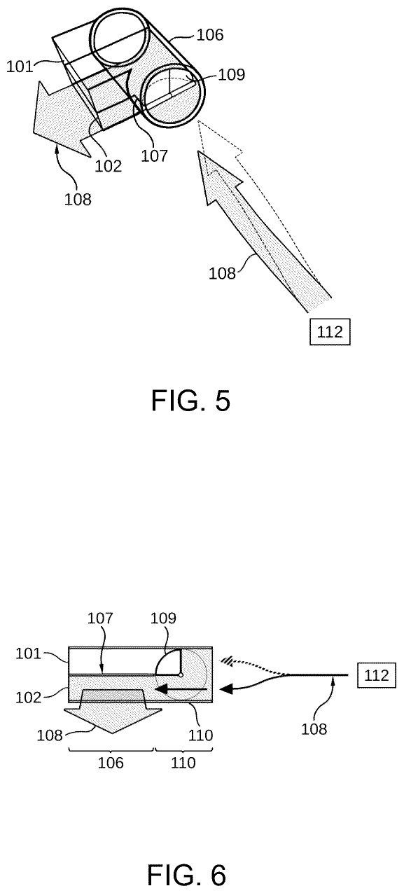

As shown in FIGS. 1-3, valve 109 has been actuated to close the entrance of second exhaust duct 102 in exhaust duct inlet 106 thereby directing vector force 108 from a thrust module solely to first exhaust duct 101 such that the propulsion system is actuated to produce exhaust thrust vector 113 through first exhaust outlet 104 at an angle of 90 degrees relative to horizontal plane X. FIGS. 4-6 show valve 109 actuated to a position to close first exhaust duct 101 such that vector force 108 from a thrust module is being directed solely to second exhaust duct 102 to produce exhaust thrust vector 113 through second exhaust outlet 105 at an angle of 180 relative to horizontal plane X. Valve 109 can assume any configuration suitable for directing forced air, or a liquid, to one or a combination of first exhaust duct 101 and second exhaust duct 102. In some non-limiting embodiments, valve 109 is a butterfly valve having a geometry that interfaces with the inside walls of valve housing 110.

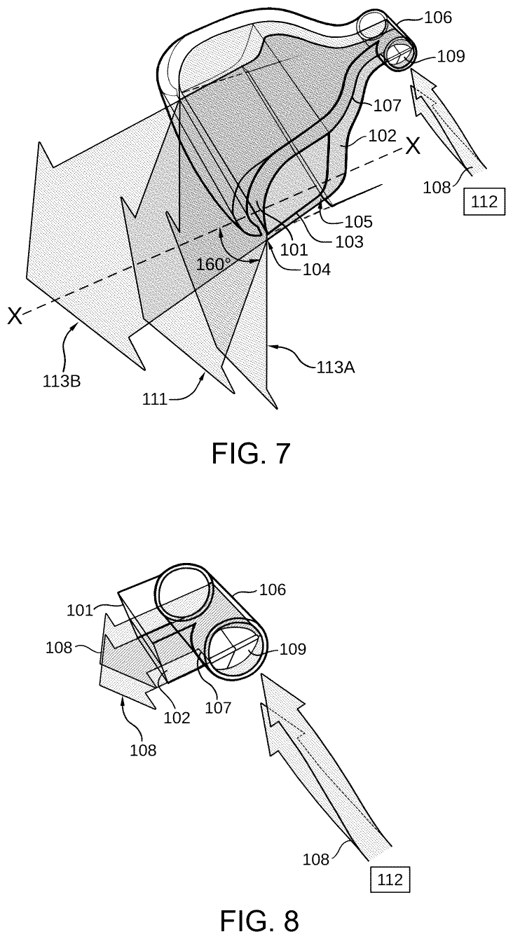

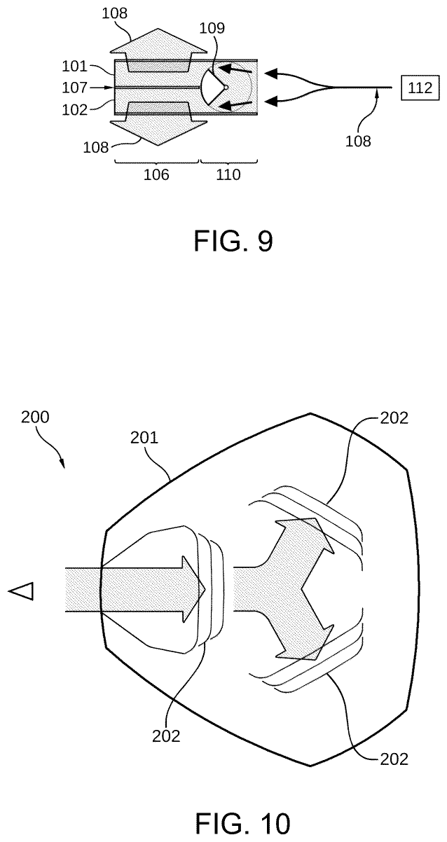

FIGS. 7-9 show valve 109 actuated to a position wherein both first exhaust duct 101 and second exhaust duct 102 are open to valve housing 110 so as to permit vector force 108 from a thrust module to be directed to the exhaust ducts simultaneously. This positioning of valve 109 produces exhaust thrust vector 113A through first exhaust outlet 104 and exhaust thrust vector 113B through second exhaust outlet 105 such that the exhaust thrust vectors collide to produce combined exhaust thrust vector 111. That is, vector force 108 is apportioned between first exhaust duct 101 and second exhaust duct 102 such that the exhaust thrust vectors exiting first exhaust outlet 104 and second exhaust outlet 105 combine to produce an exhaust thrust at an angle between about 90 degrees and about 180 degrees relative to horizontal plane X. It will be appreciated that the angle of thrust of combined exhaust thrust vector 111 can be modulated by controlling the relative amount of vector force that is allocated between first exhaust duct 101 and second exhaust duct 102 through actuation of valve 109. For example, actuating valve 109 to allocate a relatively greater amount of vector force 108 to first exhaust duct 101 will produce a combined exhaust thrust vector 111 that is biased towards a vertical exhaust thrust (e.g., between 75 and 90 degrees) relative to horizontal plane X. Alternatively, actuating valve 109 to allocate a relatively greater amount of vector force 108 to second exhaust duct 102 will produce combined exhaust thrust vector 111 that is biased towards a horizontal exhaust thrust (e.g., between 160 and 180 degrees) relative to horizontal plane X.

Valve 109 is in mechanical communication with a driving means that is adapted to rotate valve 109 within valve housing 110 between positions wherein vector force 108 is directed to first exhaust duct 101, second exhaust duct 102, or a combination thereof. Suitable driving means for use with the invention include, but are not necessarily limited to, motors, solenoids, pneumatics, hydraulics, or combinations thereof. It will further be appreciated that the driving means can be in communication with a control (e.g., remote control) to permit a user to remotely actuate valve 109 to apportion relative amounts of vector force 108 between first exhaust duct 101 and second exhaust duct 102.

FIG. 10 shows a plan view of aerial drone 200 incorporating the inventive propulsion system. The propulsion system can be incorporated within drone body 201 of aerial drone 200 such that the outside contours of the drone can be free of any protruding features of the propulsion system thereby providing the drone with a smooth surface profile and improved aerodynamic performance over conventional drones having external, propeller-based propulsion systems. In addition, incorporating the inventive propulsion system within drone body 201 greatly reduces the noise produced by operating the propulsion system. Aerial drone 200 is shown incorporating three sets of inlets 202.

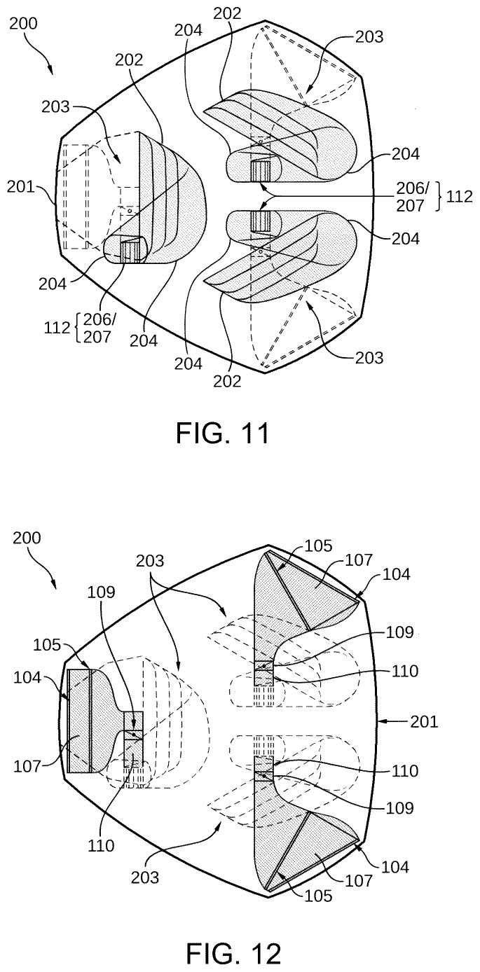

FIG. 11 shows a top, cross-sectional view of drone 200 including inlets 202. Inlets 202 are openings that traverse the upper surface of drone body 201 and are adapted to place the atmosphere surrounding drone 200 in fluid communication with thrust modules 112 through intake ducts 204. That is, inlets 202 feed air or other medium from the environment surrounding drone 200 into thrust modules 112 through intake ducts 204. In the embodiment depicted in FIGS. 10 and 11, inlets 202 are each a series of three longitudinal vents. Without being limited to any particular theory or mechanism, arranging inlets 202 as vents provides a narrow intake that reduces the amount of noise from thrust modules 112 that escapes from the inside of drone 200 by increasing the surface area of inlets 202 and intake ducts 204 such that the increased surface area contacts, and absorbs, sound waves from thrust modules 112. While inlets 202 are depicted as longitudinal vents, it will be appreciated that inlets 202 can assume any shape or configuration, or number of openings, suitable for feeding air or other medium through intake modules 203 to the thrust modules 112. For example, inlets 202 can assume a series of one, two, three, four, or more, openings, and have a cross-sectional shape that is circular, rectangular, or elliptical.

FIG. 12 shows a bottom, cross-sectional view of drone 200 which includes first exhaust outlets 104 and second exhaust outlets 105 which traverse drone body 201 and permit the exit of exhaust thrust vectors from the bottom of the drone. As shown, drone 200 incorporates thrust modules 112 in fluid communication with valve housings 110, exhaust duct inlets 106, first exhaust ducts 101, second exhaust ducts 102, first exhaust outlets 104 and second exhaust outlets 105. Suitable thrust modules for use with the inventive propulsion system include, but are not necessarily limited to, impellors, turbines, ramjets, or combinations thereof. The thrust modules can be driven by electric motors that are powered by one or more batteries housed within drone 200. While FIG. 10 shows drone 200 incorporating three individual thrust modules 112, it will be appreciated that drone 200 can include a thrust module 112 that is in fluid communication with two or more valve housings 110. For example, drone 200 can include a single thrust module 112 in communication with the three valve housings 110 depicted in FIG. 10.

In the embodiment shown in FIGS. 11 and 12, drone 200 includes three of the inventive propulsion systems. However, it will be appreciated that drones incorporating the inventive propulsion system can incorporate any number of the system suitable for driving a drone. For example, drones incorporating the inventive propulsion system can have one, two, three, four, five or more of the systems.

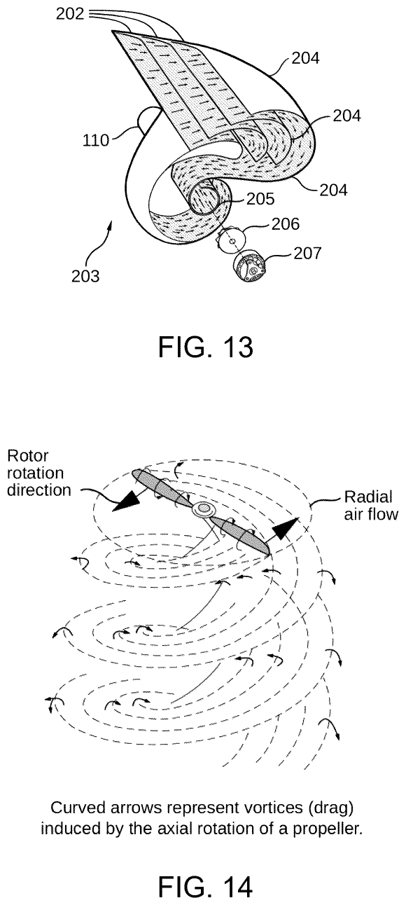

FIG. 13 shows an embodiment of an intake module 203 for use with the invention. In the depicted embodiment, intake module 203 comprises inlets 202 in fluid communication with intake ducts 204. Intake ducts 204 individually terminate in an opening that places each intake duct 204 in fluid communication with thrust module duct 205 which is adapted to channel atmospheric air, or other medium, to thrust module 112 which comprises impeller 206 in mechanical communication with motor 207. Thus, thrust module duct 205 forms a conduit that feeds environmental air or other medium from intake ducts 204 to thrust module 112. Thrust module duct 205, in turn, is in fluid communication with valve housing 110 so as to permit forced air, or other forced medium (e.g., a fluid), from thrust module 112 to form vector force 108 which is then acted upon by valve 109 and directed to first exhaust duct 101, second exhaust duct 102, or a combination thereof.

In some embodiments, thrust module duct 205 forms a housing that encases thrust module 112. FIG. 13 shows an exploded view of a thrust module for use with the invention wherein the thrust module comprises impeller 206 in mechanical communication with motor 207. In some embodiments, impeller 206 and motor 207 are housed within thrust module duct 205. In operation, activation of motor 207 rotates impeller 206 thereby producing negative pressure in thrust module duct 205 resulting in environmental air (or other medium) being drawn through inlets 202, intake ducts 204 and into thrust module duct 205. The rotation of impeller 206 acts upon the drawn air to produce positive pressure to create vector force 108 which is acted upon by valve 109 to direct vector force 108 to one or a combination of first exhaust duct 101 and second exhaust duct 102 which then escapes through one or both of first exhaust outlet 104 and second exhaust outlet 105 to produce exhaust thrust vector 113 or combined thrust vector 111, depending upon the thrust angle that is selected by a user through actuation of valve 109.

As with the other ducts of the inventive propulsion system, intake ducts 204 comprise a lumen surrounded by walls that are adapted to conduct air or other medium through the length of the ducts. In some embodiments, the walls of the ducts include a sound-suppressing material that is adapted to absorb the noise produced by operation of thrust modules 112. The walls can be formed from, and/or coated with, one or more layers of the sound-suppressing material. In some embodiments, drone body 201 can similarly be layered with and/or constructed from, sound suppressing materials to dampen the sound produced by the operation of the thrust modules within drone body 201. Suitable sound suppressing materials for use with the invention include, but are not necessarily limited to, acoustic foam, acoustic composites, acoustic dampening voids, or combinations thereof.

In some embodiments, one or more of intake ducts 204 are curved, arranged in a spiral configuration, or a combination thereof, in order to further reduce the noise produced by operation of thrust modules 112. Without being bound to any particular theory or mechanism, as sound waves travel in straight lines, arranging intake ducts 204 as a curve or spiral reduces noise by permitting the walls of the ducts to trap and absorb sound within intake module 203.

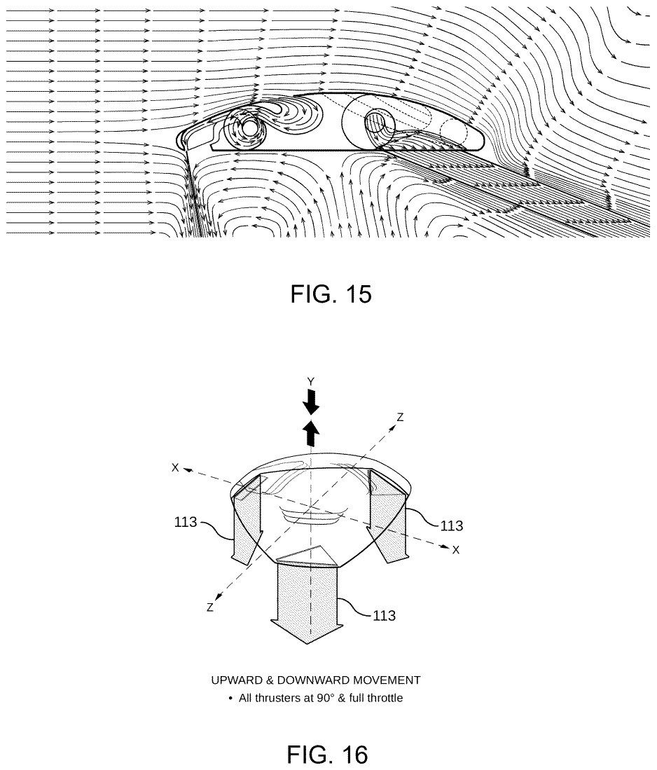

In one aspect, the inventive propulsion system provides greater efficiency than conventional, propeller-based drone systems. As shown in FIG. 14, and without being limited to any particular theory or mechanism, exposed propeller-based propulsion systems produce drag against the rotor blades due to vortices created around the tips of the rotor blades counteracting lift generation. The inventive, duct-based propulsion system, in contrast, avoids the vortices and drag produced by propeller-based propulsion. Moreover, the inventive duct-based propulsion system can entrain air from the environment supplementing the thrust produced by thrust modules 112. As shown in FIG. 15, and without being limited to any particular theory or mechanism, the duct-based inventive propulsion system permits thrust modules 112 to enhance their force by entraining environmental air such that exhaust thrust vector 113 from second exhaust outlet 105, combines with exhaust thrust vector 113 from first exhaust outlet 104 to form combined exhaust thrust vector 111 which cooperates with atmospheric air to increase the amount of thrust produced by the system's thrust modules.

FIG. 16 shows the direction of travel of drone 200 wherein the drone is moving upward under the action of exhaust thrust vectors 113 which are produced by the cooperation of three of the inventive propulsion system, wherein exhaust thrust vectors 113 are exiting from first exhaust outlets 104. It will be understood that under this direction of travel, valves 109 are actuated to direct vector force 108 from thrust modules 112 solely to first exhaust ducts 101. It will further be understood that drone 200 can move in a downward direction by a user inputting a level of thrust to the propulsion systems that is insufficient to overcome gravitational pull on drone 200.

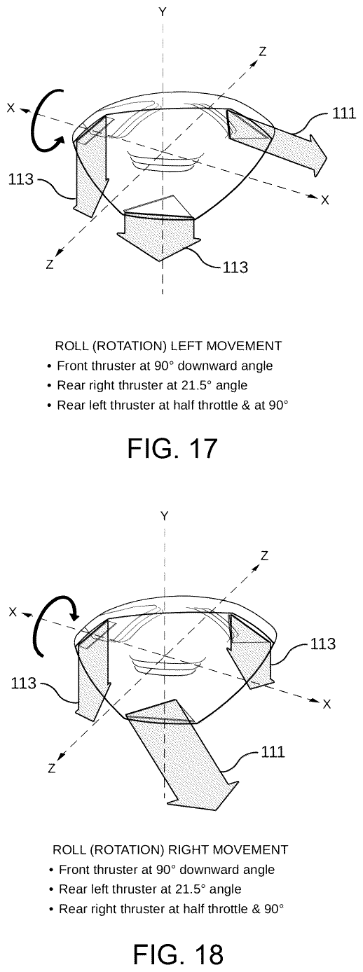

FIGS. 17 and 18 show a direction of travel of drone 200 with the drone rotating about a horizontal axis under the action of exhaust thrust vectors 113 and combined exhaust thrust vector 111 which are produced by the cooperation of three of the inventive propulsion system, wherein exhaust thrust vectors 113 are exiting from first exhaust outlets 104, and combined exhaust thrust vector 111 is produced by exhaust thrust vectors 113A and 113B exiting and combining from a first exhaust outlet 104 and a second exhaust outlet 105. It will be understood that under this direction of travel, exhaust thrust vectors 113 are produced by valves 109 being actuated to direct vector force 108 from thrust modules 112 solely to first exhaust ducts 101, and combined exhaust thrust vector 111 is produced by valve 109 being actuated to direct vector force 108 to first exhaust duct 101 and second exhaust duct 102 simultaneously.

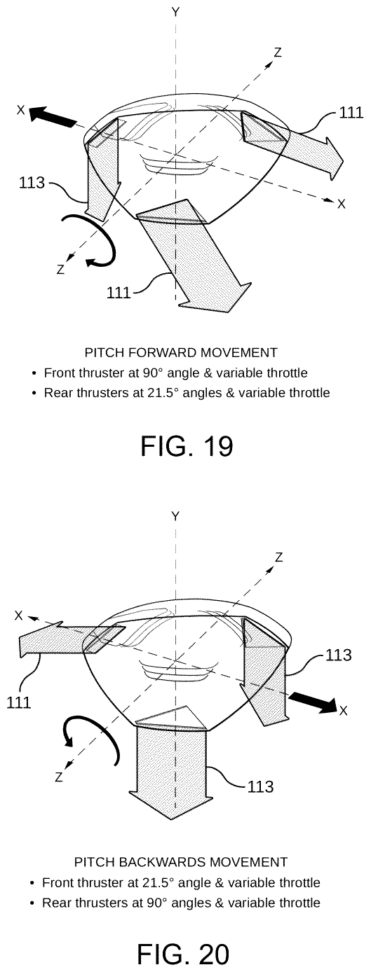

FIG. 19 shows a direction of travel of drone 200 wherein the drone is moving forward under the action of exhaust thrust vector 113 and combined exhaust thrust vectors 111 as produced by the cooperation of three of the inventive propulsion system. In this direction of travel, it will be appreciated that exhaust thrust vector 113 is exiting from first exhaust outlet 104 and combined exhaust thrust vectors 111 are achieved by the combination of vector forces 113A and 113B exiting from first exhaust outlets 104 and second exhaust outlets 105. It will be understood that under this direction of travel, a valve 109 is actuated to direct vector force 108 from a thrust module 112 solely to a first exhaust duct 101 to produce exhaust thrust vector 113, while combined exhaust thrust vectors 111 are achieved by valves 109 being in a position to direct vector force 108 from thrust modules 112 to first exhaust ducts 101 and second exhaust ducts 102 simultaneously.

FIG. 20 shows a direction of travel of drone 200 wherein the drone is moving backwards under the action of exhaust thrust vectors 113 and combined exhaust thrust vector 111 as produced by the cooperation of three of the inventive propulsion system. In this direction of travel, it will be appreciated that exhaust thrust vectors 113 are exiting from first exhaust outlets 104 and combined exhaust thrust vector 111 is achieved by the combination of exhaust thrust vectors 113A and 113B exiting from first exhaust outlet 104 and second exhaust outlet 105 simultaneously. It will be understood that under this direction of travel, valves 109 are actuated to direct vector forces 108 from thrust modules 112 solely to first exhaust ducts 101 to produce thrust vectors 113, while combined exhaust thrust vector 111 is achieved by a valve 109 being in a position to direct vector force 108 from a thrust module 112 to a first exhaust duct 101 and a second exhaust duct 102 simultaneously.

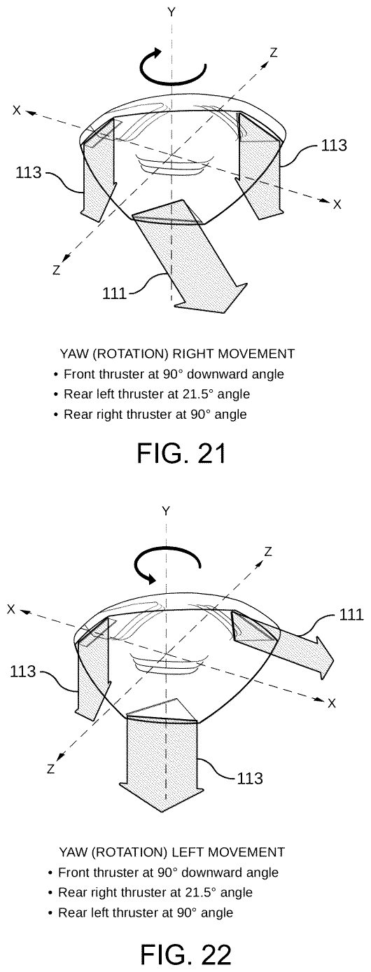

FIGS. 21 and 22 show a direction of travel of drone 200 wherein the drone is rotating about a vertical axis under the action of exhaust thrust vectors 113 and combined exhaust thrust vector 111 as produced by the cooperation of three of the inventive propulsion system. In this direction of travel, it will be appreciated that exhaust thrust vectors 113 are exiting from first exhaust outlets 104 and combined exhaust thrust vector 111 is achieved by the combination of exhaust thrust vectors 113A and 113B exiting from a first exhaust outlet 104 and a second exhaust outlet 105 simultaneously. It will be understood that under this direction of travel, exhaust thrust vectors 113 are achieved by valve 109 directing vector force 108 from thrust modules 112 solely to first exhaust ducts 101, while combined exhaust thrust vector 111 is achieved by valve 109 being in a position to direct vector force 108 from a thrust module 112 to a first exhaust duct 101 and a second exhaust duct 102 simultaneously.

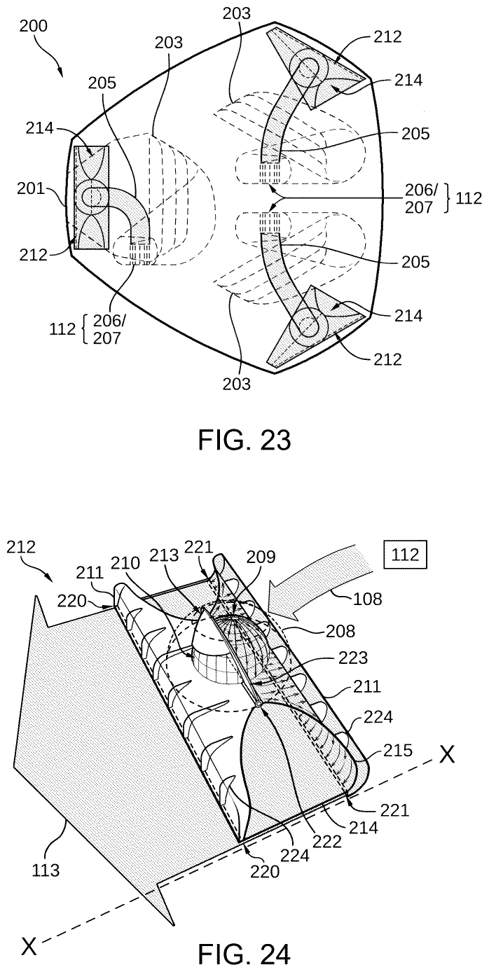

FIG. 23 shows a cross-sectional view of aerial drone 200 incorporating three of an embodiment of the inventive propulsion system. As shown, thrust module ducts 205 are in fluid communication with impellers 206 and motors 207 which form thrust module 112. As with other embodiments of the inventive propulsion system, thrust module ducts 205 can house impellers 206 and motors 207, or be at a terminal end of thrust module ducts 205. In the embodiment shown in FIG. 23, thrust module ducts 205 form an extended body that places impellers 206 and motors 207 in fluid communication with valve housings 208 so as to conduct vector force, in the form of forced air or other medium, from impellers 206 and motors 207 to valve housings 208. Thrust module ducts 205 connect to valve housings 208 around the peripheries of valve housing openings 209 on the upper surfaces of valve housings 208.

FIG. 24 provides a top perspective view of an embodiment of exhaust duct housing 212 showing valve housing 208 is a hemispherical body which surrounds valve mount 210, which is a substantially hemispherical body, such that a void is formed between valve housing 208 and valve mount 210. Valve housing 208 is mounted to first exhaust duct housing surface 211 on the top of exhaust duct housing 212, while valve mount 210 is mounted to second exhaust duct housing surface 215 and is rotatably connected to scoop valve 213. First exhaust duct housing surface 211 and second exhaust duct housing surface 215 can have cutouts 214 to reduce the amount of material used in the manufacture of exhaust duct housing 212 thereby reducing the overall weight of drone 200. In the embodiment of drone 200 shown in FIG. 23, exhaust duct housing surfaces 211 and 215 on the right side of the drone have a single cutout 214, while exhaust duct housing surfaces 211 and 215 on the left of the drone have a pair of cutouts 214.

As shown in FIG. 24, exhaust duct housing 212 comprises valve housing opening 209 on the top of valve housing 208. Valve housing 208 is connected to first exhaust duct housing surface 211 about the bottom periphery of valve housing 208, wherein the bottom periphery of valve housing 208 defines the inside edges of first exhaust duct housing surface 211. That is, the edge of first exhaust duct housing surface 211 terminates at its connection with the bottom periphery of valve housing 208 such that a valve mount opening is formed in first exhaust duct housing surface 211, wherein the valve mount opening matches the cross-sectional profile of the opening in the bottom of valve housing 208. Valve mount 210 is connected to, and rises above the plane of, second exhaust duct housing surface 215 such that valve mount 210 occupies the valve mount opening beneath valve housing 208 and forms receiving voids 216 and 217 between the lower surface of valve housing 208 and the upper surface of valve mount 210. Receiving voids 216 and 217, in turn, are in fluid communication with a planar void that is formed between first exhaust duct housing surface 211 and second exhaust duct housing surface 215. Receiving voids 216 and 217 and the planar void are in fluid communication with duct portions 218 and 219 which terminate in exhaust outlets 220 and 221 which are adapted to permit vector force to escape from exhaust duct housing 212 as exhaust thrust vectors. Thus, exhaust duct housing 212 is adapted to receive vector force (e.g., forced air or other forced medium) through thrust module duct 205 through valve housing opening 209 such that the vector force is then conducted to thrust receiving voids 216 and 217 between valve housing 208 and valve mount 210 whereupon the vector force is further conducted to the planar void between first exhaust duct housing surface 211 and second exhaust duct housing surface 215 and to duct portions 218 and 219 so that the vector force can escape exhaust outlets 220 and 221 as exhaust thrust vectors. It will be appreciated that with the exception of exhaust outlets 220 and 221, first exhaust housing surface 211 and second exhaust housing surface 215 are joined about the peripheral profile of exhaust duct housing 212 so as to force vector force out exhaust outlets 220 and 221.

Exhaust outlets 220 and 221 are adapted to produce exhaust thrust vectors at a desired angle, relative to horizontal plane X. In a preferred embodiment, exhaust outlet 220 is adapted to produce exhaust thrust vector 113 at an angle of about 90 degrees relative to horizontal plane X while exhaust outlet 221 is adapted to produce exhaust thrust vector 113 at angle of about 180 degrees relative to horizontal plane X. Exhaust outlet 220 can be adapted to produce an exhaust thrust vector of about 90 degrees relative to horizontal plane X by being equipped with an opening cross section that is parallel to horizontal plane X, while exhaust outlet 221 can be adapted to produce an exhaust thrust vector of about 180 degrees relative to horizontal plane X by being equipped with an opening cross section that is perpendicular to horizontal plane X.

Exhaust outlets 220 and 221 preferably form longitudinal openings along at least a portion of the length of exhaust duct housing 212. In preferred embodiments, exhaust outlets 220 and 221 are vents so as to produce planar exhaust thrust vectors (e.g., blades) of forced air or other medium. Non-limiting cross-sectional shapes for exhaust outlets 220 and 221 include, but are not limited to, rectangular, oval, elliptical, crescent-shaped, or combinations thereof. In a preferred embodiment, exhaust outlets 220 and 221 are longitudinal vents having a width of 1 to 2 mm. In some embodiments, exhaust duct housing 212 comprises louvers 224 which form pillars within the planar void formed between first exhaust duct housing surface 211 and second exhaust duct housing surface 215. Louvers 224 function to direct vector force from duct portions 218 and 218 to exhaust outlets 220 and 221 and strengthen the construction of exhaust duct housing 212.

FIG. 24 shows valve mount 210 rotatably connected to scoop valve 213 about hinge point 222. Hinge point 222 can comprise a pair of pins on opposing sides of valve mount 210 which are rotatably connected to scoop valve 213 through a pair of openings on scoop valve arms 223, wherein the openings rotatably mate with the pins. Alternatively, hinge point 222 can comprise an axle that traverses the width of, and extends beyond the outside edges of, valve mount 210 to rotatably engage openings in scoop valve arms 223.

The upper end of scoop valve 213 is adapted to mate with upper inside surface of valve housing 108, while the lower surface of scoop valve 213 is adapted to mate with the upper surface of valve mount 210, so as to apportion vector force from thrust module duct 205 to one or a combination of receiving voids 216 and 217. That is, scoop valve 213 has a profile wherein the upper surface of the valve mates with the upper inside surface of valve housing 208, and the lower surface of the valve mates with the upper surface of valve mount 210 such that scoop valve 213, valve housing 208 and valve mount 210 are adapted to prevent, or inhibit, the conduction of vector force to receiving voids 216 and 217, depending on the positioning of scoop valve 213. Meanwhile, scoop valve arms 223 function to bifurcate the planar void between first exhaust duct housing surface 211 and second exhaust duct housing surface 215 such that the apportionment of vector force to opposing sides of the planar void is controlled by scoop valve 213. That is, scoop valve arms 223 prevent vector force from traversing the lower sides of valve mount 210. This is accomplished, in part, by scoop valve arms 223 and the upper end of scoop valve 213 having a profile that matches the profile of valve mount 210.

FIG. 24 shows scoop valve 213 is actuated to a position wherein vector force is being apportioned solely to receiving void 217, duct portion 219, and exhaust outlet 221 such that exhaust thrust vector 113 is escaping exhaust duct housing 212 as a single exhaust thrust vector at an angle of 180 degrees relative to horizontal plane X. It will be appreciated that scoop valve 213 can be actuated to a position desired by a user by being in mechanical communication with a driving means. Suitable driving means for use with the invention include, but are not necessarily limited to, motors, solenoids, pneumatics, hydraulics, or combinations thereof. It will further be appreciated that the driving means can be in communication with a control (e.g., remote control) to permit a user to remotely actuate scoop valve 213 to apportion relative amounts of vector force between receiving voids 216 and 217 and duct portions 218 and 219.

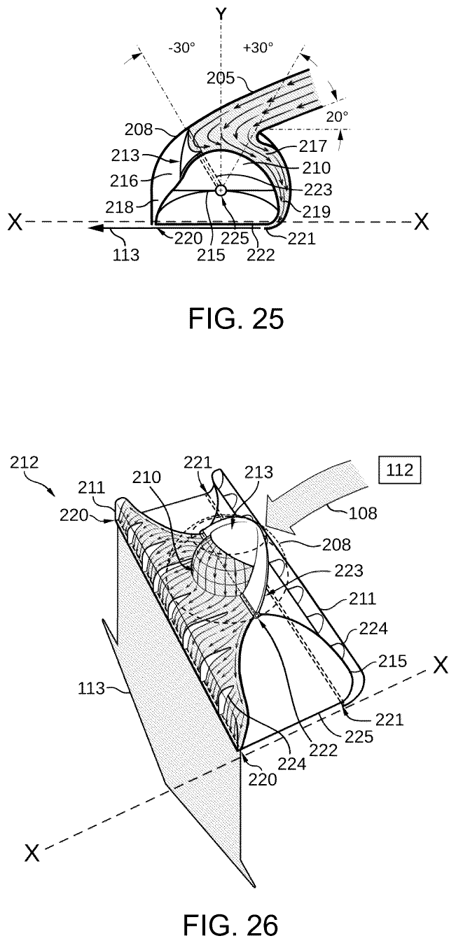

FIG. 25 shows a cross-sectional view of exhaust duct housing 212 from FIG. 24, including valve housing 208, valve mount 210 and scoop valve 213. As shown, scoop valve 213 is actuated to a position wherein vector force from thrust module duct 205 is being directed solely to receiving void 217 and duct portion 219 such that exhaust thrust vector 113 escapes exhaust outlet 221 at an angle of 180 degrees relative to horizontal plane X. As shown in the figure, exhaust thrust vector 113 runs parallel to bottom surface 225 of exhaust duct housing 212. Further as shown in the figure, scoop valve 213 is actuated to a position of −30 degrees relative to horizontal plane X such that the top of scoop valve 213 contacts the upper inside surface of valve housing 208 (where valve housing opening 209 meets thrust module duct 205) and the lower surface of valve mount 210 so as to form a closure to the passage of vector force to receiving void 216. FIG. 25 shows that in preferred embodiments, thrust module duct 205 connects to valve housing 208 at an angle of 20 degrees relative to horizontal plane X.

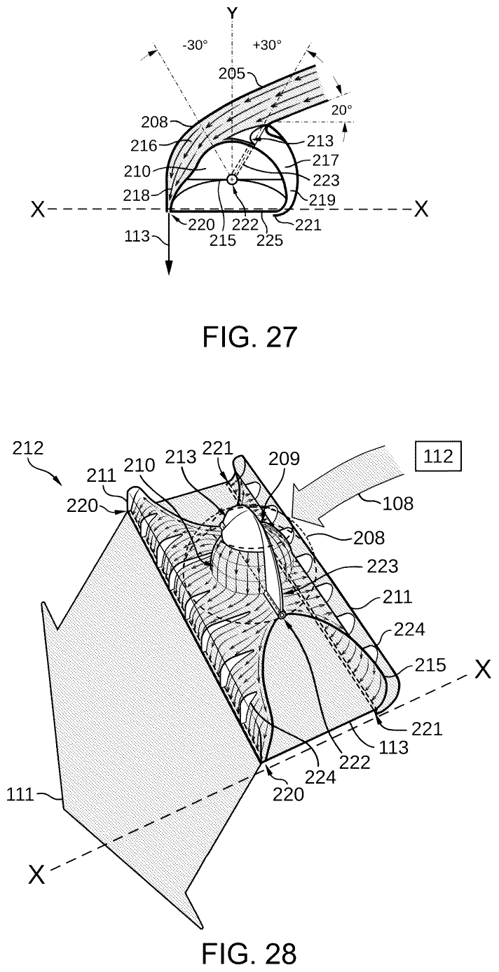

FIGS. 26 and 27 show exhaust duct housing 212 with scoop valve 213 actuated to a position wherein vector force from thrust module duct 205 is being directed solely to receiving void 216 and duct portion 218 such that exhaust thrust vector 113 escapes exhaust duct housing 212 through exhaust outlet 220 at an angle of 90 degrees relative to horizontal plane X. FIG. 27 is a cross-sectional view of valve housing 208 and valve mount 210 from FIG. 26 showing scoop valve 213 actuated to a position of +30 degrees relative to horizontal plane X such that the top of scoop valve 213 contacts the upper inside surface of valve housing 208 (where valve housing opening 209 meets thrust module duct 205) and the lower surface of valve mount 210 so as to form a closure to the passage of vector force to receiving void 217. FIG. 26 shows that scoop valve arms 223 prevent the passage of vector force around the lower surface of valve mount 210 such that the vector force is prevented from passing into receiving void 217 and duct portion 219. While FIG. 26 shows only one of scoop valve arms 223, it will be appreciated that the opposing scoop valve arm and opposing side of scoop valve 213 is a mirror image of the scoop valve arm and portion of scoop valve 213 expressly depicted in FIG. 26.

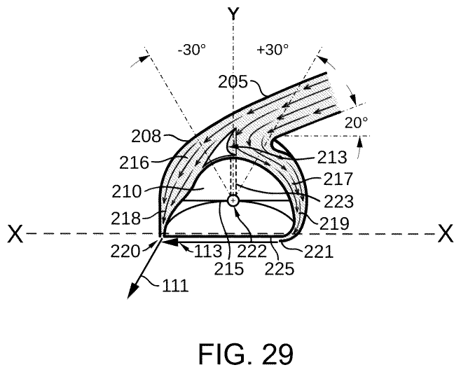

FIGS. 28 and 29 show exhaust duct housing 212 with scoop valve 213 actuated to a position wherein vector force from thrust module duct 205 is being directed to receiving void 216 and duct portion 218, and receiving void 217 and duct portion 219, simultaneously such that exhaust thrust vector 113 escapes exhaust outlet 221 at an angle of 180 degrees relative to horizontal plane X and collides with the exhaust thrust vector escaping exhaust outlet 220 to produce combined thrust vector 111 at an angle between 90 degrees and 180 degrees relative to horizontal plane X. FIG. 29 is a cross-sectional view of valve housing 208 and valve mount 210 from FIG. 28 showing scoop valve 213 actuated to a position of 90 degrees relative to horizontal plane X such that the top of scoop valve 213 occupies the void created where valve housing opening 209 meets thrust module duct 205 so as apportion vector force to receiving voids 216 and 217 simultaneously.

As with the embodiment of the inventive propulsion system depicted in FIGS. 6-9, it will be appreciated that the angle of thrust of combined exhaust thrust vector 111 can be modulated by controlling the relative amount of vector force that is allocated between receiving voids 216 and 217 through actuation of scoop valve 213. For example, actuating scoop valve 213 to allocate a relatively greater amount from thrust module duct 205 to receiving void 216 will produce a combined exhaust thrust vector 111 that is biased towards a vertical exhaust thrust (e.g., between 75 and 90 degrees) relative to horizontal plane X. Alternatively, actuating scoop valve 213 to allocate a relatively greater amount of vector force from thrust module duct 205 to receiving void 217 will produce combined exhaust thrust vector 111 that is biased towards a horizontal exhaust thrust (e.g., between 160 and 180 degrees) relative to horizontal plane X.

It will further be appreciated that drone 200 incorporating three of the inventive propulsion system incorporating the features disclosed in FIGS. 23-29 will be capable of the directions of travel and movements shown in FIGS. 16-22.

The directions of travel and movements of a drone incorporating the inventive propulsion system, as disclosed FIGS. 16-22, are non-limiting examples of possible directions of travel and movements. It will be appreciated that these, and other directions of travel and movements, can be achieved by varying the number and arrangement of the inventive propulsion system that is incorporated into a drone or other vehicle. Directions of travel and movements can be modulated by varying the amount of relative thrust that is directed to individual propulsion systems within a series of propulsion systems, varying the angle of exhaust thrust vectors being produced by individual propulsion systems within a series of propulsion systems, or a combination thereof. It will further be appreciated that one or more of the inventive propulsion systems can be in electrical communication with one or more processors that are adapted to: receive raw inputs from a user for a desired direction of travel and/or movement; and execute instructions to the one or more propulsion systems so as to coordinate and execute the desired direction of travel and/or movement.

While the inventive propulsion system has been disclosed as being incorporated into aerial drone 200, it will be appreciated that the propulsion system can be incorporated into any vehicle capable of being driven by ducted thrust as disclosed herein. Thus, the inventive propulsion system can also find use in powering manned aerial vehicles, as well as manned and unmanned terrestrial and aquatic vehicles. In some non-limiting applications, the inventive propulsion system can be used to drive amphibious vehicles capable of traveling through air and on, or through, water.

While specific embodiments of the inventive device have been described in detail in the foregoing detailed description, it will be appreciated by those skilled in the art that various modifications and alternatives to those details could be developed in light of the teachings of the disclosure. It is understood, therefore, that the scope of this disclosure is not limited to the particular examples and implementations disclosed herein, but is intended to cover modifications within the spirit and scope thereof as defined by the appended claims and any and all equivalents thereof.

### REFERENCE CHARACTERS

101—First Exhaust Duct
102—Second Exhaust Duct
103—Exhaust Thrust Plane
104—First Exhaust Outlet
105—Second Exhaust Outlet
106—Exhaust Duct Inlet
107—Separation Body
108—Vector Force
109—Valve
110—Valve Housing
111—Combined Exhaust Thrust Vector
112—Thrust Module
113—Exhaust Thrust Vector
200—Aerial Drone
201—Drone Body
202—Inlets
203—Intake Module
204—Intake Ducts
205—Thrust Module Duct
206—Impeller
207—Motor
208—Valve Housing
209—Valve Housing Opening
210—Valve Mount
211—First Exhaust Duce Housing Surface
212—Exhaust Duct Housing
213—Scoop Valve
214—Cutout
215—Second Exhaust Housing Surface
216—Receiving Void
217—Receiving Void
218—Duct Portion
219—Duct Portion
220—Exhaust Outlet
221—Exhaust Outlet
222—Hinge Point
223—Scoop Valve Arms
224—Louvers
225—Bottom Surface

1. A propulsion system, comprising:
a) a thrust module;
b) at least one inlet in fluid communication with the thrust module;
c) a first duct having in a first outlet, wherein the first duct is in fluid communication with the thrust module;
d) a second duct having a second outlet, wherein the second duct is in fluid communication with the thrust module; and
e) a valve in fluid communication with the thrust module, the first duct and the second duct, wherein the valve is adapted to direct vector force from the thrust module to the first duct, the second duct, and a combination thereof.

2. The propulsion system of claim 1, wherein the first outlet is adapted to direct vector force from the thrust module at a first angle relative to a horizontal plane, and the second outlet is adapted to direct vector force from the thrust module at a second angle relative to the horizontal plane.

3. The propulsion system of claim 2, wherein the first angle is about 90 degrees and the second angle is about 180 degrees.

4. The propulsion system of claim 2, wherein the valve is adapted to direct vector force from the thrust module to the first duct and the second duct simultaneously to permit the first outlet and the second outlet to produce a combined vector force at a third angle relative to the horizontal plane, wherein the third angle that is between the first angle and the second angle.

5. The propulsion system of claim 4, wherein the third angle is between about 90 degrees and about 180 degrees relative to the horizontal plane.

6. The propulsion system of claim 1, wherein the thrust module is selected from an impellor, turbine and ramjet.

7. The propulsion system of claim 6, wherein the impellor is in mechanical communication with a motor.

8. The propulsion system of claim 1, wherein the first outlet and the second outlet have a cross-sectional shape that is polygonal, oval, circular or combinations thereof.

9. The propulsion system of claim 1, wherein the first outlet and the second outlet each comprise longitudinal slit.

10. The propulsion system of claim 1, wherein the valve is housed within a first hemispherical body and rotatably connected to a second hemispherical body.

11. The propulsion system of claim 10, wherein a void is formed between the first hemispherical body and the second hemispherical body.

12. The propulsion system of claim 11, wherein (i) the void is in fluid communication with the first outlet and the second outlet, and (ii) the valve is adapted to direct vector force to the first outlet or the second outlet by contacting the first hemispherical body and the second hemispherical body.

13. The propulsion system of claim 1, wherein at least one of the first duct and the second duct are curved, arranged in a spiral configuration, or combination thereof.

14. The propulsion system of claim 1, wherein at least one of the first duct and the second duct comprise an acoustic foam, at least one layer of acoustic plastic, acoustic dampening voids, or combinations thereof.

15. The propulsion system of claim 1, wherein the inlet has an inner wall that comprises acoustic foam, at least one layer of acoustic plastic, acoustic dampening voids, or combinations thereof.

16. The propulsion system of claim 1, wherein the propulsion system is incorporated into an aerial drone.

17. The propulsion system of claim 16, wherein the aerial drone incorporates a plurality of the propulsion system.

18. The propulsion system of claim 16, wherein the aerial drone incorporates a plurality of the propulsion system.

19. The propulsion system of claim 17, wherein the plurality of propulsion systems are in electronic communication with a remote control that is adapted coordinate the operation of the plurality of propulsion systems.
